(19) United States
(12) Patent Application Publication
(10) Pub. No.: US 2016/0362106 A1
(43) Pub. Date: Dec. 15, 2016

(54) DRIVE ASSIST DEVICE FOR VEHICLE

(71) Applicant: TOYOTA JIDOSHA KABUSHIKI KAISHA, Toyota-shi (JP)

(72) Inventors: Takashi MAEDA, Nagoya-shi (JP); Kyoichi ABE, Gotenba-shi (JP)

(73) Assignee: TOYOTA JIDOSHA KABUSHIKI KAISHA, Toyota-shi (JP)

(21) Appl. No.: 15/176,505

(22) Filed: Jun. 8, 2016

(30) Foreign Application Priority Data
Jun. 9, 2015 (JP) 2015-116223

(51) Int. Cl. B60W 30/165; B60W 10/04; B60W 10/18

(52) U.S. Cl. CPC B60W 30/165; B60W 10/18; B60W 10/04; B60W 2420/52; B60W 2420/42; B60W 2520/10; B60W 2520/14; B60W 2540/20; B60W 2550/10; B60W 2720/106

(57) ABSTRACT

[Objective] A possibility that a sense of discomfort or insecurity may be given to a driver when a self-vehicle overtakes a preceding vehicle in a follow-up control should be reduced.

[Means for Solution] A target follow-up acceleration calculation part 13 calculates target follow-up acceleration Afollow*. This target follow-up acceleration Afollow* is set so as to become a larger value when an overtaking operation is detected based on a winker signal, compared with a case where an overtaking operation is not detected. A target acceleration mediation part 16 selects a smallest value among the target follow-up acceleration Afollow*, target constant speed running acceleration Aconst* and target curve running acceleration Acurve*, and sets the selected value as final target acceleration A*.

### TECHNICAL FIELD

The present invention relates to a drive assist device for a vehicle, which makes a self-vehicle run so as to follow a preceding vehicle.

### BACKGROUND ART

Conventionally, a drive assist device for a vehicle, which makes a self-vehicle run so as to follow a preceding vehicle running ahead of the self-vehicle in order to reduce driving operation by a driver, has been known. Such a control for making a self-vehicle follow a preceding vehicle is referred to as a follow-up control. In the follow-up control, target acceleration for making a self-vehicle follow a preceding vehicle is calculated, and an engine or a brake control system is controlled based on this target acceleration. A device proposed in the Patent Document 1 (PTL1) is configured to increase the target acceleration when a driver's intention to overtake a preceding vehicle is detected based on an operating condition of a direction indicator (blinker).

### CITATION LIST

### Patent Literature

[PTL1] Japanese Patent Application Laid-Open “kokai” No. H05-156977

### SUMMARY OF INVENTION

However, the conventional device increases target acceleration when a driver's intention to overtake a preceding vehicle (overtaking intention) is detected based on an operating condition of a direction indicator, regardless of whether a road where a self-vehicle is running is straight or curved. For example, while running on a curved road, although target acceleration according to a radius of curvature (curve radius) of the road is set, target acceleration for cornering (curve running) is multiplied by an acceleration gain for overtaking when a driver's overtaking intention is detected. As a result, target acceleration which is not really suitable for curve running may be set. For this reason, when a driver performs overtaking operation during curve running, there is a possibility that a sense of discomfort or insecurity may be given to the driver.

The present invention is made in order to solve the above-mentioned problem, and one of objects thereof is to reduce a possibility that a sense of discomfort or insecurity may be given to a driver when a self-vehicle overtakes a preceding vehicle on a road which is curved or on a road which begins to be curved in a follow-up control.

In order to attain the above-mentioned objective, a feature of the present invention is in that,

a drive assist device for a vehicle, which carries out a follow-up control that is a control for making a self-vehicle follow up a preceding vehicle while maintaining an inter-vehicular distance from said self-vehicle to said preceding vehicle at a distance within a predetermined range, comprises:

a detection means (11, 24) to detect that a direction indicator of said self-vehicle is in an operating condition,

a first calculation means (13) to calculate target overtaking acceleration which is target acceleration required for said self-vehicle to overtake said preceding vehicle when it is detected that said direction indicator is in an operating condition during an execution of said follow-up control,

a second calculation means (15) to calculate target curve running acceleration which is target acceleration for curve running according to a radius of curvature of a road where said self-vehicle is running,

a target acceleration selection means (16) to acquire, as target acceleration candidates, a plurality of kinds of target acceleration including said target overtaking acceleration and said target curve running acceleration at least, and to select, as final target acceleration, minimum target acceleration among said acquired plurality of kinds of target acceleration, when it is detected that said direction indicator is in an operating condition, and a driving force control means (17, 30) to control driving force of said self-vehicle based on said final target acceleration and actual acceleration of said self-vehicle so that said self-vehicle accelerates with said final target acceleration.

A drive assist device for a vehicle, according to the present invention, carries out a follow-up control that is a control for making a self-vehicle follows up a preceding vehicle while maintaining an inter-vehicular distance from the self-vehicle to the preceding vehicle at a distance within a predetermined range. The drive assist device for a vehicle comprises a detection means a first calculation means, a second calculation means, a target acceleration selection means, and a driving force control means. When overtaking the preceding vehicle in the follow-up control, a driver operates a direction indicator. An operating condition of this direction indicator is detected by the detection means. The first calculation means calculates target overtaking acceleration which is target acceleration required for the self-vehicle to overtake the preceding vehicle, when it is detected that the direction indicator is in an operating condition during an execution of the follow-up control.

The second calculation means calculates target curve running acceleration which is target acceleration for curve running according to a radius of curvature of a road where the self-vehicle is running. For example, the second calculation means acquires information showing a radius of curvature or curve curvature of the road on which the self-vehicle is running and calculates target curve running acceleration which is set to such a smaller value that a radius of curvature becomes smaller (such a smaller value that a curve curvature becomes larger).

The target acceleration selection means acquires, as target acceleration candidates, a plurality of kinds of target acceleration including the target overtaking acceleration and the target curve running acceleration at least, and selects, as final target acceleration, minimum target acceleration among the acquired plurality of kinds of target acceleration, when it is detected that the direction indicator is in an operating condition. The driving force control means controls driving force of the self-vehicle based on the final target acceleration and actual acceleration of the self-vehicle so that the self-vehicle accelerates with the final target acceleration.

Therefore, according to the present invention, when overtaking a preceding vehicle, target acceleration can be limited to be below the target curve running acceleration. As a result, a possibility that a sense of discomfort or insecurity may be given to a driver can be reduced, when a self-vehicle overtakes a preceding vehicle on a road which is curved or on a road which begins to be curved in a follow-up control.

A feature of one aspect of the present invention is in that,

the drive assist device for a vehicle further comprises a third calculation means (14) to calculate target constant speed running acceleration which is target acceleration for constant speed running for making said self-vehicle run at set speed that a driver sets, and

said target acceleration selection means (16) is configured to acquire, as target acceleration candidates, a plurality of kinds of target acceleration including said target overtaking acceleration and said target curve running acceleration and said target constant speed running acceleration at least, and to select, as final target acceleration, minimum target acceleration among said acquired plurality of kinds of target acceleration, when it is detected that said direction indicator is in an operating condition.

In the one aspect of the present invention, the drive assist device for a vehicle further comprises a third calculation means. This third calculation means calculate target constant speed running acceleration which is target acceleration for constant speed running for making the self-vehicle run at set speed that a driver sets. Therefore, for example, when any preceding vehicle does not exist ahead of the self-vehicle, the self-vehicle can be controlled so as to run at the set speed using this target constant speed running acceleration. In the one aspect of the present invention, the target acceleration selection means acquires, as target acceleration candidates, a plurality of kinds of target acceleration including the target overtaking acceleration and the target curve running acceleration and the target constant speed running acceleration at least, and selects, as final target acceleration, minimum target acceleration among the acquired plurality of kinds of target acceleration, when it is detected that the direction indicator is in an operating condition. Therefore, even when the self-vehicle changes lanes and a preceding vehicle ahead of the self-vehicle disappears, the self-vehicle can be properly accelerated based on the target constant speed running acceleration. Moreover, the speed of the self-vehicle can be limited to be below the set speed that the driver set.

Although reference signs used in embodiments are attached in parenthesis to constituent elements of the present invention corresponding to the embodiments in the above-mentioned explanation in order to help understanding of the present invention, respective constituent elements of the present invention are not limited to the embodiments specified with the above-mentioned reference signs.

### BRIEF DESCRIPTION OF DRAWINGS

FIG. 1 is a schematic system configuration diagram of a drive assist device for a vehicle, according to a present embodiment.

FIG. 2 is a functional block diagram of a drive assist ECU.

FIG. 3 is a graph showing a map of target inter-vehicular time.

FIG. 4 is a graph showing a target constant speed running acceleration gain map.

### DESCRIPTION OF EMBODIMENTS

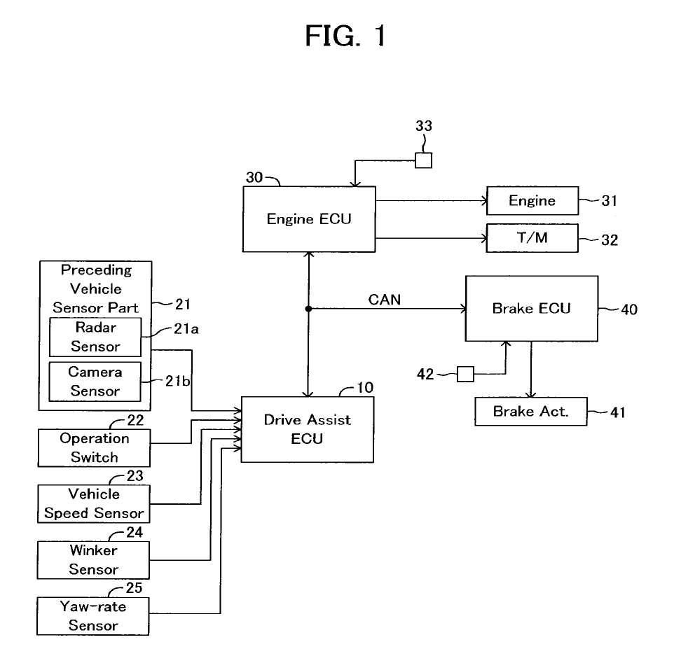

Hereafter, embodiments of the present invention will be explained in detail using drawings. FIG. 1 is a schematic system configuration diagram of a drive assist device for a vehicle, according to a present embodiment.

The drive assist device for a vehicle, according to the present embodiment, comprises a drive assist ECU 10. This drive assist ECU 10 is an electronic control unit for assisting driving operation by a driver, and comprises a microcomputer as a principal part. The drive assist ECU 10 according to the present embodiment makes a self-vehicle to follow up a preceding vehicle while maintaining an inter-vehicular distance between a preceding vehicle and a self-vehicle at a suitable distance according to vehicle speed, and makes the self-vehicle to run at constant speed that a driver sets when any preceding vehicle does not exist, and thereby assists driving operation by the driver.

The drive assist ECU 10 is connected to a preceding vehicle sensor part 21, an operation switch 22, a speed sensor 23, a winker sensor 24 and a yaw-rate sensor 25. The preceding vehicle sensor part 21 has a function to acquire information of a preceding vehicle which exists ahead of a self-vehicle, and comprises a radar sensor 21a and a camera 21b, for example. The preceding vehicle sensor part 21 just has to be a device which can detect a preceding vehicle and a distance between a self-vehicle and a preceding vehicle and does not necessarily have both the radar sensor 21a and the camera 21b, and may be configured to comprise either of them or another sensor.

The radar sensor 21 a irradiates an electric wave in a millimeter waveband ahead and receives a reflected wave from a preceding vehicle when the preceding vehicle exists, for example. And, the radar sensor 21a calculates an existence of a preceding vehicle, a distance between a self-vehicle and the preceding vehicle (referred to as a preceding vehicle inter-vehicle distance) and a relative velocity between the self-vehicle and the preceding vehicle (referred to as a preceding vehicle relative velocity), etc., based on an irradiating timing, a receiving timing, etc. of the electric wave, and outputs a calculation result to the drive assist ECU 10. The camera 21b is a stereo camera, and takes photographs of right and left sceneries ahead of the vehicle, for example. Based on image data of the right and left sceneries thus photographed, the camera 21b calculates an existence of a preceding vehicle, a preceding vehicle inter-vehicle distance and a preceding vehicle relative velocity, etc., and outputs a calculation result to the drive assist ECU 10. Hereafter, information showing an existence of a preceding vehicle, a vehicle inter-vehicle distance and a preceding vehicle relative velocity, etc. will be referred to as preceding vehicle information.

The operation switch 22 is a switch which operates by operation of a driver, and outputs this operation signal to the drive assist ECU 10. This operation switch 22 outputs the following operation signals.
(1) ON and OFF of Drive Assist Function
(2) Switching between Constant Speed Control Mode and Follow-up control mode
(3) Setting of Vehicle Speed for Constant Speed Running
(4) Setting of Inter-vehicular Distance in Follow-up control mode (Long, Medium and Short)

Constant speed control is carried out in the constant speed control mode. In the follow-up control mode, follow-up control is carried out when a preceding vehicle exists, and constant speed control is carried out when a preceding vehicle does not exist (when a preceding vehicle which becomes a target of inter-vehicular control is not caught). The constant speed control is control which makes a self-vehicle run at a set vehicle speed set by the operation switch 22. The follow-up control is control which makes a self-vehicle follow up a preceding vehicle while maintaining an inter-vehicular distance between the preceding vehicle and the self-vehicle in a suitable distance according to vehicle speed based on preceding vehicle information. When the constant speed control or the follow-up control is carried out, an accelerator operation by a driver becomes unnecessary.

The operation switch 22 does not need to be configured so that one operation element (lever, etc.) attains the above-mentioned function, and may be configured so that the above-mentioned function is realized by combining a plurality of operation elements. The drive assist ECU 10 memorizes parameters (vehicle speed for constant speed running, an inter-vehicular distance between at the time of follow-up control, etc.) which a driver sets using the operation switch 22 in a non-volatile memory. Vehicle speed for constant speed running, which a driver sets using the operation switch 22, is referred to as set vehicle speed Vset.

The speed sensor 23 outputs a detection signal showing vehicle speed Vn of a self-vehicle. The winker sensor 24 is a sensor which outputs a detection signal showing an operating condition of a winker (direction indicator) (whether a winker is in an operation or not). As a detection signal of the winker sensor 24, a state signal of a turn lamp is used, for example. The yaw-rate sensor 25 outputs a detection signal showing a yaw rate Yaw of a self-vehicle.

The drive assist ECU 10 is connected to the engine ECU 30 and the brake ECU 40 through CAN (Controller Area Network) so that signal can be mutually transmitted and received. The engine ECU 30 is connected with various kinds of sensors 33 which are needed for control of an engine 31 and control of a transmission 32. The engine ECU 30 carries out fuel injection control, ignition control and intake air mass control of the engine 31, based on demand driving force. Moreover, the engine ECU 30 controls gear-shift of the transmission 32 based on a shift-up line and a shift-down line which are predetermined to vehicle speed and a throttle opening.

The drive assist ECU 10 calculates target acceleration of a self-vehicle and further calculates demand driving force F* (including a negative value, i.e., demand braking force) which is needed for the self-vehicle to accelerate with this target acceleration (including deceleration in which the target acceleration is a negative value), when the constant speed control or the follow-up control is carried out. The drive assist ECU 10 transmits this demand driving force F* to the engine ECU 30. The engine ECU 30 controls the engine 31 and the transmission 32 according to the demand driving force F*. When the demand driving force F* becomes a value which needs a large braking force and the demand cannot be met only by the engine 31 and the transmission 32, the engine ECU 30 transmits demand braking force to the brake ECU 40 so that the insufficiency is generated by a hydraulic brake. In addition, when the constant speed control is carried out, the target acceleration for constant speed running is calculated so that a braking force to the extent that a hydraulic brake is needed is not be required.

The brake ECU 40 comprises a microcomputer as a principal part, and is connected to a brake actuator 41. The brake actuator 41 is disposed in a hydraulic circuit between a master cylinder which pressurizes brake oil by a brake pedal and a wheel cylinder which is built in a brake caliper of each wheel (not shown). The brake ECU 40 is connected with various kinds of sensors 42 which are needed for control of the brake actuator 41. The brake ECU 40 controls an operation of the brake actuator 41 and makes a wheel generate friction braking force, based on the demand braking force.

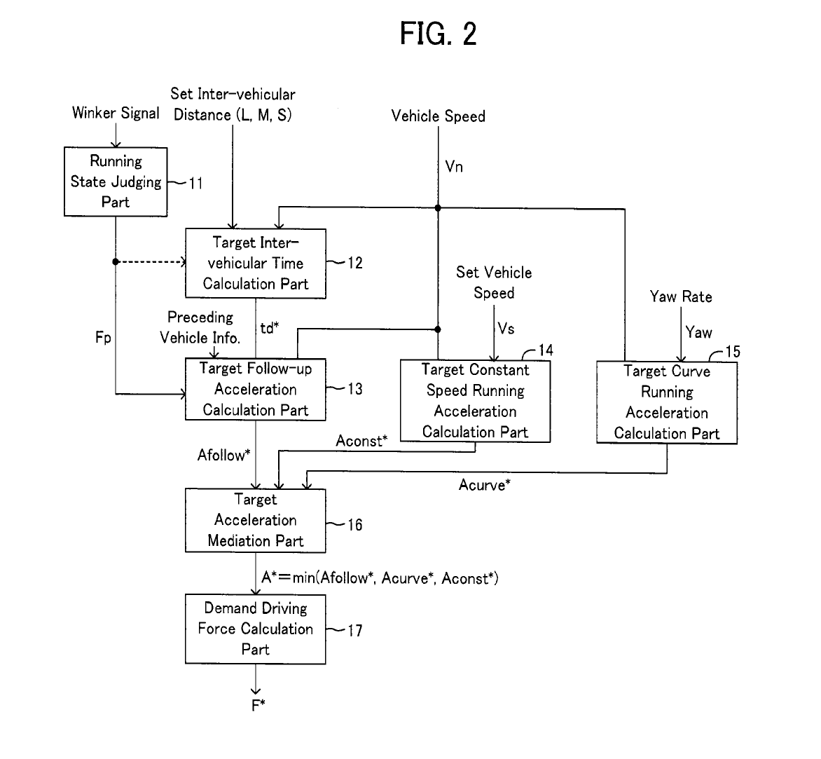

Next, a function of the drive assist ECU 10 will be explained. FIG. 2 is a functional block diagram of a microcomputer prepared in the drive assist ECU 10. The drive assist ECU 10 comprises an overtaking running state judging part 11, a target inter-vehicular time calculation part 12, a target follow-up acceleration calculation part 13, a target constant speed running acceleration calculation part 14, a target curve running acceleration calculation part 15, a target acceleration mediation part 16, and a demand driving force calculation part 17. In parallel, respective control blocks (11 to 17) repeatedly carry out calculation processing which will be mentioned later in a predetermined calculation period. In addition, practically, a CPU of the drive assist ECU 10 executes a program (instruction) stored in a ROM of the drive assist ECU 10, and thereby functions of these respective control blocks (11 to 17) are realized. Moreover, although the drive assist ECU 10 uses various kinds of sensor detection values in an execution of various kinds of calculations, the sensor detection values are the newest value at a time point of calculation, unless there is an notice.

### <Overtaking Running State Judging Part>

The overtaking running state judging part 11 is a control block which judges a state that a driver is trying to overtake a preceding vehicle. The overtaking running state judging part 11 reads a winker signal showing a state that a winker control lever is operated rightward or leftward, in a predetermined calculation period. In the present embodiment, a turn lamp signal showing an operation situation of a turn lamp is read as the winker signal. When a winker operation lever is operated, a state signal of a turn lamp repeats ON and OFF in a predetermined period. However, the overtaking running state judging part 11 judges that it is in a state that the winker is operating, during a period when the state signal of the turn lamp is repeating ON and OFF, even if the state signal of a turn lamp is OFF.

The overtaking running state judging part 11 sets an overtaking flag Fp to “1” while the turn lamp signal is repeating ON and OFF in a predetermined period, and sets the overtaking flag Fp to “0” otherwise. Therefore, it can be estimated whether a self-vehicle is overtaking (includes an overtaking preparatory in which overtaking has not been completed) according to the overtaking flag Fp. The overtaking running state judging part 11 supplies an overtaking flag Fp to the target follow-up acceleration calculation part 13.

### <Target Inter-vehicular Time Calculation Part>

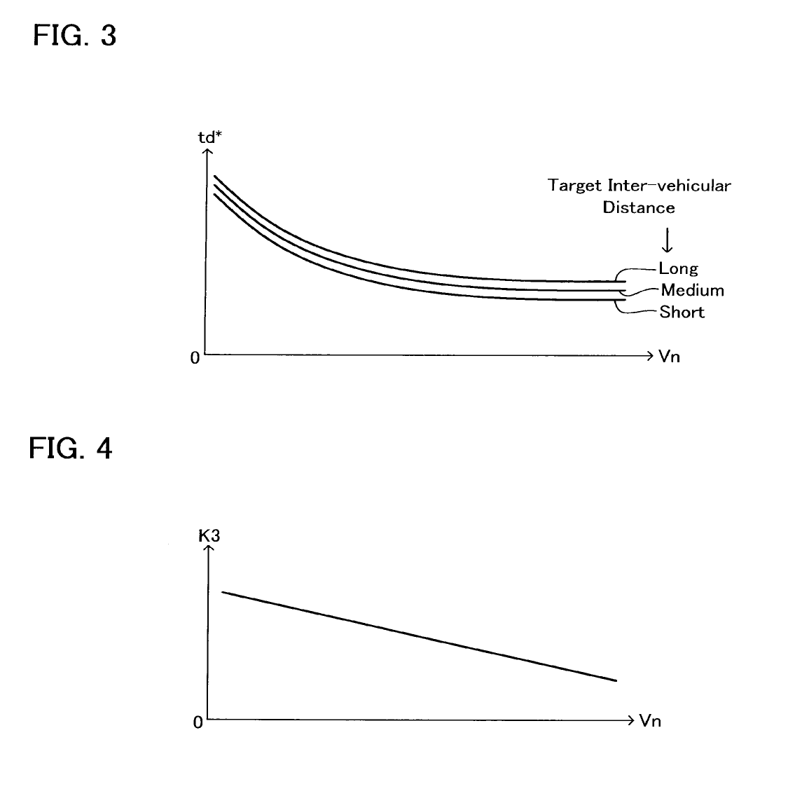

The target inter-vehicular time calculation part 12 is a control block which calculates an inter-vehicular time in a case where a self-vehicle follows up a preceding vehicle. The target inter-vehicular time calculation part 12 calculates the target inter-vehicular time based on the vehicle speed Vn detected by the speed sensor 23 and a set inter-vehicular distance (long, medium and short) which a driver sets and is memorized. More specifically, the target inter-vehicular time calculation part 12 has memorized a target inter-vehicular time map. The target inter-vehicular time map has a property that target inter-vehicular time td* which becomes shorter as the vehicle speed Vn is faster and the target inter-vehicular distance is shorter, as shown in FIG. 3 is set up. The target inter-vehicular time calculation part 12 calculates (computes) the target inter-vehicular time td* by applying the vehicle speed Vn and the set inter-vehicular distance to the target inter-vehicular time map. The target inter-vehicular time calculation part 12 supplies the computed target inter-vehicular time td* to the target follow-up acceleration calculation part 13.

### <Target Follow-up Acceleration Calculation Part>

The target follow-up acceleration calculation part 13 is a control block which calculates the target acceleration used as the fundamentals in a case where a preceding vehicle is detected and the follow-up control is carried out. The overtaking flag Fp set by the overtaking running state judging part 11, the target inter-vehicular time td* calculated by the target inter-vehicular time calculation part 12, the preceding vehicle information (a preceding vehicle inter-vehicular distance, preceding vehicle relative velocity) transmitted from the preceding vehicle sensor part 21 and the vehicle speed Vn detected by the speed sensor 23 are inputted to the target follow-up acceleration calculation part 13, and the target follow-up acceleration Afollow* is calculated.

The target follow-up acceleration calculation part 13 calculates target follow-up acceleration Afollow1* on acceleration side, and target follow-up acceleration Afollow2* deceleration side, as shown in the following formulas (1) and (2). The target follow-up acceleration calculation part 13 adopts the target follow-up acceleration Afollow2* on deceleration side as the target follow-up acceleration Afollow* (Afollow*=Afollow2*) when the target follow-up acceleration Afollow2* on deceleration side becomes a negative value (Afollow2*<0 m/s²), and adopts the target follow-up acceleration Afollow1* on acceleration side as the target follow-up acceleration Afollow* (Afollow*=Afollow1*) otherwise.

Afollow1*=((ΔD×K1)+(Vr×K2))×Ka (1)

Afollow2*=((ΔD×K1)+(Vr×K2)) (2)

Here, ΔD is a inter-vehicular deviation which will be mentioned later, K1 and K2 are gains, Vr is a preceding vehicle relative velocity which will be mentioned later, and Ka is a gain on acceleration side. Moreover, a lower limit of the target follow-up acceleration Afollow1* on acceleration side is set to zero, and the target follow-up acceleration Afollow1* on acceleration side is set to zero by a lower limit processing when a calculation result is a negative value. Moreover, an upper limit of the target follow-up acceleration Afollow2* on deceleration side is set to zero, and the target follow-up acceleration Afollow2* on deceleration side is set to zero by an upper limit processing when a calculation result is a positive value.

The inter-vehicular deviation ΔD is a value which is obtained by subtracting the target inter-vehicular distance (computed by multiplying the target inter-vehicular tome td* by the vehicle speed Vn) from an actual a preceding vehicle inter-vehicular distance. Therefore, in a situation where the actual a preceding vehicle inter-vehicular distance is longer than the target inter-vehicular tome td*, the inter-vehicular deviation ΔD becomes a positive value, and acts so as to increase the target follow-up acceleration Afollow*.

The gains K1 and K2 are positive values for an adjustment, and they may be fixed values or values which are adjusted by other parameters.

The preceding vehicle relative velocity Vr is a relative velocity of a preceding vehicle to a self-vehicle, and is a value which is obtained by subtracting vehicle speed of the self-vehicle from vehicle speed of the preceding vehicle. Therefore, in a situation where a preceding vehicle runs away from a self-vehicle, the preceding vehicle relative velocity Vr becomes a positive value, and acts s as to increase the target follow-up acceleration Afollow*.

The acceleration side gain Ka is a positive value which adjusts the extent of the target follow-up acceleration Afollow1 on acceleration side with respect to the target follow-up acceleration Afollow2 on deceleration side. This acceleration side gain Ka is set to a larger value when the overtaking flag Fp is “1”, as compared with that when the overtaking flag Fp is “0.” For example, when the acceleration side gain Ka in a case where the overtaking flag Fp is “0” is Ka0 and the acceleration side gain Ka in a case where the overtaking flag Fp is “1” is Ka1, they have a relation of Ka0<Ka1.

Therefore when it is in a state that the direction indicator (winker) is operating (when there is a driver's intention to overtake a preceding vehicle), a larger target follow-up acceleration Afollow1* on acceleration side is calculated, as compared with a case where it is in a state that the winker is not operating. This acceleration side gain Ka1 is set to a value with which target overtaking acceleration for overtaking a preceding vehicle is obtained. The target follow-up acceleration Afollow1 on acceleration side calculated by applying the acceleration side gain Ka1 to the above-mentioned formula (1) is equivalent to target overtaking acceleration.

The target follow-up acceleration calculation part 13 calculates the target follow-up acceleration Afollow* in a predetermined calculation period, and supplies the calculated target follow-up acceleration Afollow* to the target acceleration mediation part 16 each time. In addition, the target follow-up acceleration calculation part 13 sets, as the target follow-up acceleration Afollow*, a large value which a self-vehicle cannot generate as a matter of practice, when any preceding vehicle is not detected.

### <Target Constant Speed Running Acceleration Calculation Part>

The target constant speed running acceleration calculation part 14 is a control block which calculates target acceleration in a case where the constant speed control is carried out. Based on the vehicle speed Vn detected by the speed sensor 23 and the set vehicle speed Vset which the driver sets using the operation switch 22, the target constant speed running acceleration calculation part 14 calculates target constant speed running acceleration Aconst*, as shown in the following formula (3).

Aconst*=(Vset−Vn)×K3 (3)

Here, K3 is an acceleration gain for constant speed running, and is set to a positive value according to the vehicle speed Vn. More specifically, the target constant speed running acceleration calculation part 14 has memorized an acceleration gain map for constant speed running. For example, as shown in FIG. 4, this acceleration gain map for constant speed running has a property that, as compare with a case where the vehicle speed Vn is low, a smaller acceleration gain K3 for constant speed running is set when the vehicle speed Vn is high. The target constant speed running acceleration calculation part 14 computes an acceleration gain K3 for constant speed running by applying the actual vehicle speed Vn to the acceleration gain map for constant speed running.

Target constant speed running acceleration Aconst* which acts so as to accelerate a self-vehicle is calculated when the vehicle speed deviation (Vset−Vn) in the first term on the right-hand side of the formula (3) is positive, and target constant speed running acceleration Aconst* which acts so as to decelerates the self-vehicle is calculated when the vehicle speed deviation (Vset−Vn) is negative.

The target constant speed running acceleration calculation part 14 calculates the target constant speed running acceleration Aconst* in a predetermined calculation period, and supplies the calculated target constant speed running acceleration Aconst* to the target acceleration mediation part 16 each time.

### <Target Curve Running Acceleration Calculation Part>

The target curve running acceleration calculation part 15 is a block which calculates target curve running acceleration Acurve* which is target acceleration in a case where a self-vehicle is running in a curved road. The target curve running acceleration calculation part 15 calculates the target curve running acceleration Acurve* based on the vehicle speed Vn detected by the speed sensor 23 and the yaw rate Yaw detected by the yaw-rate sensor 25 using the following formulae (4), (4-1) and (4-2).

Acurve*=(Vcurve−Vn)×K4 (4)

Here, Vcurve is an allowable speed permitted at the time of curve running, and is calculated by the following formula (4-1). sqrt means a function which calculates a value of a square root.

Vcurve=sqrt(R×Gcy) (4-1)

R is a estimated curve radius of a road in a location where the self-vehicle is running, and is calculated by the following formula (4-2). Kr is a conversion factor. In addition, the estimated curve radius R can be calculated from lines of right and left lane markers (white line) of a running lane detected by the camera sensor 21b, for example.

R=Kr×(Vn/Yaw) (4-2)

Furthermore, Gcy is lateral acceleration permitted in curve running, and is set beforehand. K4 is a gain with a predetermined magnitude.

A lower limit of the target curve running acceleration Acurve* is set to zero, and the target curve running acceleration Acurve* is set to zero by lower limit processing when a calculation result is a negative value.

The target curve running acceleration calculation part 15 calculates the target curve running acceleration Acurve* in a predetermined calculation period, and supplies the calculated target curve running acceleration Acurve* to the target acceleration mediation part 16 each time.

### <Target Acceleration Mediation Part>

To the target acceleration mediation part 16, the target follow-up acceleration Afollow* calculated by the target follow-up acceleration calculation part 13, the target constant speed running acceleration Aconst* calculated by the target constant speed running acceleration calculation part 14 and the target curve running acceleration Acurve* calculated by the target curve running acceleration calculation part 15 are inputted.

As shown in the following formula (5), the target acceleration mediation part 16 selects a smallest value among the target follow-up acceleration Afollow*, the target constant speed running acceleration Aconst* and the target curve running acceleration Acurve* which are inputted, and sets the selected value as the target acceleration A*.

A*=min(Afollow*, Aconst*, Acurve*) (5)

Here, min means a function which chooses the minimum of the numerical value in a parenthesis.

The target acceleration mediation part 16 repeatedly carries out calculation processing (minimum selection processing) of the target acceleration A* in a predetermined calculation period. As mentioned above, the target follow-up acceleration Afollow* is set to a larger value when the overtaking flag Fp is set to “1”, as compared with a case where the overtaking flag Fp is set to “0.” Therefore, larger target follow-up acceleration Afollow* is set when the driver has an intention to overtake a preceding vehicle, as compared with a case where the drive does not have such an intention.

Since a conventional device is configured to multiply the target curve running acceleration by an acceleration gain for overtaking when a driver is trying to overtake a preceding vehicle and the run way curves, as a result, target acceleration which is not really suitable for curve running may be set. On the other hand, in the present embodiment, the target follow-up acceleration Afollow*, the target constant speed running acceleration Aconst* and the target curve running acceleration Acurve* are calculated in parallel, and the smallest value among them is selected and set as the target acceleration A*. For this reason, at the time of overtaking a preceding vehicle, the target follow-up acceleration Afollow* is never set as the target acceleration A* when the target follow-up acceleration Afollow* is larger than the target curve running acceleration Acurve*.

Moreover, since the target follow-up acceleration Afollow* is set to a very large value as mentioned above when a preceding vehicle disappears ahead of a self-vehicle and it is switched to the constant speed control after overtaking a preceding vehicle, substantially, the target follow-up acceleration Afollow* is removed from the candidates of target acceleration A*. Therefore, the target constant speed running acceleration Aconst* is compared with the target curve running acceleration Acurve*. Thereby, when the target constant speed running acceleration Aconst* is larger than the target curve running acceleration Acurve*, the target curve running acceleration Acurve* is set as the target acceleration A*.

The target acceleration mediation part 16 calculates the target acceleration A* in a predetermined calculation period (minimum selection processing), and supplies the calculated target acceleration A* to the demand driving force calculation part 17 each time.

### <Demand Driving Force Calculation Part>

The demand driving force calculation part 17 calculates acceleration deviation ΔA (=A*−An) which is a deviation between the target acceleration A* and actual acceleration An which is real acceleration of the self-vehicle, and calculates demand driving force F* based on this acceleration deviation ΔA. For example, the demand driving force calculation part 17 sets, as demand driving force F*, a value which is obtained by adding the demand driving force F*(n−1) one calculation period before to a value obtained by multiplying the acceleration deviation ΔA by the gain K5, as shown in the following formula (6).

F*=(A*−An)×K5+F*(n−1) (6)

The demand driving force calculation part 17 calculates the demand driving force F* in a predetermined calculation period, and supplies the calculated demand driving force F* to the engine ECU 30 each time. Thereby, a driving force is controlled so that a self-vehicle accelerates with the target acceleration A* (deceleration is also included). Therefore, a vehicle can be made to run with acceleration suitable for the follow-up control or the constant speed control. In addition, the actual acceleration An may be acquired by differential operation (calculation) of the vehicle speed Vn, and may be acquired from a detection value of a longitudinal acceleration sensor prepared in a vehicle body. When a large braking force is demanded and the demand cannot be met only by the engine 31 and the transmission 32, the engine ECU 30 transmits a demand braking force to the brake ECU 40 so that the insufficiency is generated by a hydraulic brake.

In accordance with the drive assist device for a vehicle according to the present embodiment explained above, the target follow-up acceleration Afollow*, the target constant speed running acceleration Aconst* and the target curve running acceleration Acurve* are calculated in parallel, and the smallest value among them is chosen and set as the target acceleration A*. For this reason, even when a driver tries to overtake a preceding vehicle in the follow-up control, the target acceleration A* is not set to a large value unsuitable for curve running.

For example, a case where the follow-up control mode is chosen by the operation switch 22 and a preceding vehicle is running ahead of a self-vehicle in a lane in which the self-vehicle is running is assumed. When it is in a situation where the set vehicle speed Vset of the self-vehicle is higher than the vehicle speed of the preceding vehicle, the target acceleration A* is calculated so that the self-vehicle follows up the preceding vehicle. When a driver checks an empty situation of an adjacent lane, operates a winker operation lever, and starts preparing for overtaking (lane change), the target follow-up acceleration calculation part 13 calculates target acceleration for overtaking, which is a larger value than before, as the target follow-up acceleration Afollow*. Thereby, the self-vehicle changes lanes across a lane line, while accelerating.

When a run way curves in such a situation, the target acceleration A* is limited so that it does not be exceed the target curve running acceleration Acurve* by the target acceleration mediation part 16. For this reason, in both cases when a preceding vehicle exists ahead of a self-vehicle and when a preceding vehicle disappears ahead of a self-vehicle due to lane change, the target acceleration A* can be limited so that it does not exceed the target curve running acceleration Acurve*. Moreover, the target curve running acceleration Acurve* is set to a value according to the estimated curve radius R, the vehicle speed Vn and the yaw rate Yaw. As a result, the self-vehicle can be made to run with suitable target acceleration, and a possibility that a sense of discomfort or insecurity may be given to a driver can be reduced.

Moreover, since an upper-limit restriction of the target acceleration A* works by the target constant speed running acceleration Aconst*, even when overtaking a preceding vehicle, vehicle speed of a self-vehicle can be limited so as to be the set vehicle speed Vset that the driver sets or less.

As mentioned above, although the drive assist device for a vehicle according to the present embodiment has been explained, the present invention is not limited to the above-mentioned embodiment, and various modifications are possible unless they deviate from the objective of the present invention.

For example, although a configuration wherein the overtaking flag Fp is inputted into the target follow-up acceleration calculation part 13 and the acceleration side gain Ka in a computing equation of the target follow-up acceleration Afollow* is switched according to the overtaking flag Fp is adopted in the present embodiment, in place thereof or in addition thereto, a configuration wherein the overtaking flag Fp is inputted to the target inter-vehicular time calculation part 12 (refer to the dashed-line arrow in FIG. 2) and the target inter-vehicular time is switched according to the overtaking flag Fp may be adopted, for example. In this case, it is preferable that the target inter-vehicular time td* is set to be shorter when the overtaking flag Fp is “1”, as compared with a case where it is “0.”

Moreover, although it is configured that three kinds of target acceleration are inputted and a minimal among them is selected in the target acceleration mediation part 16 in the present embodiment, at least two kinds of the target follow-up acceleration Afollow* (including the target acceleration at the time of overtaking) and the target curve running acceleration Acurve* are enough as the target acceleration inputted into the target acceleration mediation part 16, and they are not limited to three kinds. For example, the target acceleration mediation part 16 may be configured to be inputted the target follow-up acceleration Afollow* and the target curve running acceleration Acurve* and to choose smaller target acceleration among them. Moreover, for example, when the drive assist ECU 10 is configured to also carry out another drive assist control (for example, the drive assist ECU 10 has a lane keeping assist control function to assist a vehicle to run along a lane), it may be configured to an upper-limit target acceleration set by the drive assist control is additionally inputted to the target acceleration mediation part 16. Also in such a configuration, since priority is given to the smaller one of the target follow-up acceleration Afollow* and the target curve running acceleration Acurve* at the time of overtaking as a candidate of the target acceleration A*, in other words, the larger one of the target follow-up acceleration Afollow* and the target curve running acceleration Acurve* at the time of overtaking is excluded from the candidates of target acceleration, the above-mentioned function effect can be acquired.

Moreover, although the vehicle to which the drive assist device according to the present embodiment is applied is a vehicle comprising an engine as a drive source for running, the drive assist device according to the present embodiment is not limited thereto and can be applied to other vehicles, such as an electric vehicle, a hybrid vehicle and a fuel cell vehicle, for example.

### REFERENCE SIGNS LIST

10: Drive Assist ECU, 11: Running State Judging Part, 12: Target Inter-vehicular Time Calculation Part, 13: Target Follow-up Acceleration Calculation Part, 14: Target Constant Speed Running Acceleration Calculation Part, 15: Target Curve Running Acceleration Calculation Part, 16: Target Acceleration Mediation Part, 17: Demand Driving Force Calculation Part, 21: Preceding Vehicle Sensor Part, 22: Operation Switch, 23: Vehicle Speed Sensor, 24: Winker Sensor, 25: Yaw-rate Sensor, 30: Engine ECU, 31: Engine, 40: Brake ECU, A*: Target Acceleration, Aconst*: Target Constant Speed Running Acceleration, Acurve*: Target Curve Running Acceleration, Afollow*: Target Follow-up Acceleration, Afollow1*: Target Follow-up Acceleration on Acceleration Side, Afollow2*: Target Follow-up Acceleration On Deceleration Side, Fp: Overtaking Flag, Ka: Acceleration Side Gain, R: Estimated Curve Radius, td*: Target Inter-vehicular Time, Vn: Vehicle Speed, Vr: Preceding Vehicle Relative Speed, Vset: Set Vehicle Speed, Yaw: Yaw Rate.

1. A drive assist device for a vehicle, which carries out a follow-up control that is a control for making a self-vehicle follow up a preceding vehicle while maintaining an inter-vehicular distance from said self-vehicle to said preceding vehicle at a distance within a predetermined range, comprising:
a detection means to detect that a direction indicator of said self-vehicle is in an operating condition,
a first operation means to calculate target overtaking acceleration which is target acceleration required for said self-vehicle to overtake said preceding vehicle when it is detected that said direction indicator is in an operating condition during an execution of said follow-up control,
a second operation means to calculate target curve running acceleration which is target acceleration for curve running according to a radius of curvature of a road where said self-vehicle is running,
a target acceleration selection means to acquire, as target acceleration candidates, a plurality of kinds of target acceleration including said target overtaking acceleration and said target curve running acceleration at least, and to select, as final target acceleration, minimum target acceleration among said acquired plurality of kinds of target acceleration, when it is detected that said direction indicator is in an operating condition, and
a driving force control means to control driving force of said self-vehicle based on said final target acceleration and actual acceleration of said self-vehicle so that said self-vehicle accelerates with said final target acceleration.

2. The drive assist device for a vehicle, according to claim 1, further comprising:
a third operation means to calculate target constant speed running acceleration which is target acceleration for constant speed running for making said self-vehicle run at set speed that a driver sets, wherein:
said target acceleration selection means is configured to acquire, as target acceleration candidates, a plurality of kinds of target acceleration including said target overtaking acceleration and said target curve running acceleration and said target constant speed running acceleration at least, and to select, as final target acceleration, minimum target acceleration among said acquired plurality of kinds of target acceleration, when it is detected that said direction indicator is in an operating condition.
